(19) United States
(12) Patent Application Publication
(10) Pub. No.: US 2025/0385301 A1
(43) Pub. Date: Dec. 18, 2025

(54) CHALCOGEN-HALIDE SOLID ELECTROLYTES FOR LITHIUM OR SODIUM BATTERIES

(71) Applicant: Massachusetts Institute of Technology, Cambridge, MA (US)

(72) Inventors: Ju Li, Weston, MA (US); Tao Dai, Somerville, MA (US)

(73) Assignee: Massachusetts Institute of Technology, Cambridge, MA (US)

(21) Appl. No.: 18/918,593

(22) Filed: Oct. 17, 2024

Related U.S. Application Data
(60) Provisional application No. 63/614,095, filed on Dec. 22, 2023.
(60) Provisional application No. 63/665,441, filed on Jun. 28, 2024.

(51) Int. Cl. H01M 10/0562

(52) U.S. Cl. CPC H01M 10/0562; H01M 2300/0071; H01M 2300/008

(57) ABSTRACT

Described herein is a chalcogen-halide solid electrolyte material represented by the following chemical formula: LiAₓE_{y}G_{z}, or NaAₓE_{y}G_{z}. In embodiments, A denotes one or more elements selected from the group consisting of magnesium (Mg), calcium (Ca), strontium (Sr), barium (Ba), Lanthanum (La), cerium (Ce), samarium (Sm), and boron (B). In embodiments, E denotes one or more chalcogen elements. In embodiments, G denotes one or more halide elements. In embodiments, the following mathematical formula is satisfied: 0<x<10, 0<y<10, z=nx−2y+1, wherein n=3 when A denotes at least one element selected from the group consisting of La, Ce, Sm, and B, and n=2 when A denotes at least one element selected from the group consisting of Mg, Ca, Sr, and Ba. In embodiments, A is a single element selected from the group consisting of Mg, Ca, Sr, Ba, La, Ce, Sm, or B.

### CROSS REFERENCE TO RELATED APPLICATIONS

This application claims the benefit under 35 U.S.C. § 119 of U.S. Provisional Patent Application No. 63/614,095 filed on Dec. 22, 2023, and U.S. Provisional Patent Application No. 63/655,441 filed on Jun. 28, 2024, which are hereby incorporated by reference herein in their entirety.

### STATEMENT REGARDING FEDERALLY SPONSORED RESEARCH

This invention was made with government support under HR0011-22-C-0097 awarded by the Defense Advanced Research Projects Agency. The government has certain rights in the invention.

### BACKGROUND

Solid state batteries provide improved energy density and safety, compared to conventional liquid batteries. However, maintaining a chemically and mechanically stable interface between the solid electrolyte and electrode materials is notably challenging. Recently, oxychloride solid electrolytes have been reported with very high oxidation potentials (i.e., greater than or equal to 4V) and notable compatibility with most cathodes. However, these oxychloride solid electrolytes also have high reduction potential (i.e., less than or equal to 0.5 V), indicating they are not stable with a lithium or sodium metal anode. Chalcogen-halide materials can be used as solid electrolytes, which could potentially address these challenges.

### SUMMARY OF DISCLOSED EMBODIMENTS

In one aspect, the present disclosure is directed towards a chalcogen-halide solid electrolyte material, comprising: LiAₓE_{y}G_{z}, or NaAₓE_{y}G_{z}. In embodiments, A denotes one or more elements selected from the group consisting of magnesium (Mg), calcium (Ca), strontium (Sr), barium (Ba), Lanthanum (La), cerium (Ce), samarium (Sm), and boron (B). In embodiments, E denotes one or more chalcogen elements. In embodiments, G denotes one or more halide elements. In embodiments, the following mathematical formula is satisfied: 0<x<10, 0<y<10, z=nx−2y+1, wherein n=3 when A denotes at least one element selected from the group consisting of La, Ce, Sm, and B, and n=2 when A denotes at least one element selected from the group consisting of Mg, Ca, Sr, and Ba.

In embodiments, A is a single element selected from the group consisting of Mg, Ca, Sr, Ba, La, Ce, Sm, or B. In embodiments, the chalcogen elements comprises one of: oxygen (O); sulfur(S); or selenium (Se). In embodiments, the halide elements comprises one of: fluorine (F); chlorine (Cl); bromine (Br); or iodine (I). In embodiments, A contains at least one element selected from the group consisting of Mg, Ca, Sr, Ba, La, Ce, and Sm. In embodiments, A contains at least one element selected from the group consisting of La, Ce, and Sm, and the following mathematical formula is satisfied: z=3x−2y+1. In embodiments, A contains at least one element selected from the group consisting of Mg, Ca, Sr, and Ba, and the following mathematical formula is satisfied: z=2x−2y+1. In embodiments, A contains at least one element selected from the group consisting of Ca and Ba, and the following mathematical formula is satisfied: z=2x−2y+1. In embodiments, E denotes oxygen. In embodiments, In embodiments, E denotes oxygen and A contains at least one element selected from the group consisting of Mg, Ca, Sr, Ba, La, Ce, and Sm. In embodiments, E denotes oxygen and A contains at least one element selected from the group consisting of La, Ce, and Sm, and the following mathematical formula is satisfied: z=3x−2y+1. In embodiments, E denotes oxygen and A contains at least one element selected from the group consisting of Mg, Ca, Sr, and Ba, and the following mathematical formula is satisfied: z=2x−2y+1. In embodiments, E denotes oxygen and A contains at least one element selected from the group consisting of Ca and Ba, and the following mathematical formula is satisfied: z=2x−2y+1.

According to another aspect of the disclosure, a battery comprises a positive electrode, and an electrolyte layer disposed on the positive electrode, the electrolyte layer comprising a chalcogen-halide solid electrolyte material. In embodiments, the chalcogen-halide solid electrolyte material, comprising: LiAₓE_{y}G_{z}, or NaAₓE_{y}G_{z}. In embodiments, A denotes one or more elements selected from the group consisting of magnesium (Mg), calcium (Ca), strontium (Sr), barium (Ba), Lanthanum (La), cerium (Ce), samarium (Sm), and boron (B). In embodiments, E denotes one or more chalcogen elements. In embodiments, G denotes one or more halide elements. In embodiments, the following mathematical formula is satisfied: 0<x<10, 0<y<10, z=nx−2y+1, wherein n=3 when A denotes at least one element selected from the group consisting of La, Ce, Sm, and B, and n=2 when A denotes at least one element selected from the group consisting of Mg, Ca, Sr, and Ba. In embodiments, the battery includes a negative electrode disposed on the electrolyte layer.

In embodiments, A is a single element selected from the group consisting of Mg, Ca, Sr, Ba, La, Ce, Sm, or B. In embodiments, A contains at least one element selected from the group consisting of La, Ce, and Sm, and the following mathematical formula is satisfied: z=3x−2y+1. In embodiments, A contains at least one element selected from the group consisting of Ca and Ba, and the following mathematical formula is satisfied: z=2x−2y+1. In embodiments, E denotes oxygen. In embodiments, wherein E denotes oxygen, A contains at least one element selected from the group consisting of La, Ce, and Sm, and the following mathematical formula is satisfied: z=3x−2y+1. In embodiments, wherein E denotes oxygen, wherein A contains at least one element selected from the group consisting of Ca and Ba, and the following mathematical formula is satisfied: z=2x−2y+1.

### DESCRIPTION OF THE SEVERAL VIEWS OF THE DRAWINGS

The manner and process of making and using the disclosed embodiments may be appreciated by reference to the figures of the accompanying drawings. It should be appreciated that the components and structures illustrated in the figures are not necessarily to scale, emphasis instead being placed upon illustrating the principals of the concepts described herein. Like reference numerals designate corresponding parts throughout the different views. Furthermore, embodiments are illustrated by way of example and not limitation in the figures, in which:

FIG. 1A is a top view of a chalcogen-halide solid electrolyte material lithium (Li)—boron (B)—oxygen (O)—chlorine (Cl);

FIG. 1B is an exemplary schematic of a electrochemical cell, including the chalcogen-halide solid electrolyte material;

FIG. 2 is a graph of current (μA) vs. potential vs. Li/Li⁺ (V), illustrating reduction potential for a chalcogen-halide solid electrolyte material Li—B—O—Cl;

FIG. 3 is a graph of -Zimag (ohm) vs. Zreal (ohm) for a chalcogen-halide solid electrolyte material Li—B—O—Cl;

FIG. 4 is a graph of voltage (V) and current (mA) vs test time (min) for a symmetric cell using a chalcogen-halide solid electrolyte material Li—B—O—Cl;

FIG. 5 is a graph of current (μA) vs. potential vs. Li/Li⁺ (V), illustrating reduction potential for a chalcogen-halide solid electrolyte material Li-magnesium (Mg)—O—Cl;

FIG. 6 is a graph of -Zimag (ohm) vs. Zreal (ohm) for a chalcogen-halide solid electrolyte material Li—Mg—O—Cl;

FIG. 7 is a graph of voltage (V) and current (mA) vs. test time (min) for a symmetric cell using a chalcogen-halide solid electrolyte material Li—Mg—O—Cl;

FIG. 8A is a graph of current (μA) vs. potential vs. Li/Li⁺ (V), illustrating reduction potential for a chalcogen-halide solid electrolyte material Li—calcium (Ca)—sulfur(S)—lodine (I);

FIG. 8B is an enlarged view of the graph disclosed in FIG. 8A;

FIG. 9 is a graph of -Zimag (ohm) vs. Zreal (ohm) for a chalcogen-halide solid electrolyte material Li—Ca—S—I;

FIG. 10 is a graph of voltage (V) and current (mA) vs. test time (min) for a symmetric cell using a chalcogen-halide solid electrolyte material Li—Ca—S—I;

FIG. 11 is a top view of a chalcogen-halide solid electrolyte material Li—La—S—I;

FIG. 12 is a graph of -Zimag (ohm) vs. Zreal (ohm) for a chalcogen-halide solid electrolyte material Li—La—S—I; and

FIG. 13 is a graph of voltage (V) and current (mA) vs. test time (min) for a symmetric cell including a chalcogen-halide solid electrolyte material Li—La—S—I.

### DETAILED DESCRIPTION

Before describing the broad concepts, devices, systems and techniques sought to be protected herein, some introductory concepts are explained. One kind of conventional chalcogen-halide electrolyte is MACO, where M stands for lithium (Li) or sodium (Na), A stands for aluminum (AI), C stands for chlorine (Cl), and O stands for oxygen (O). Accordingly, LACO refers to an embodiment where L stands for lithium (Li) and NACO refers to an embodiment where M stands for sodium (Na). The reduction potentials of MACO are 1.45 V vs Li⁺/Li (for a MACO electrolyte where M stands for Li) and 1.55 V vs Na⁺/Na (for a MACO electrolyte where M stands for Na). Accordingly, a LACO electrolyte is not stable with an anode with a redox potential lower than 1.45 V and a NACO electrolyte is not stable with an anode with a redox potential lower than 1.55 V, thus neither is stable with a lithium metal or sodium metal anode.

Concepts described herein are directed towards replacing the Al in a LACO electrolyte to enhance the compatibility with Li metal. Accordingly, disclosed herein is a chalcogen-halide solid electrolyte material. The chalcogen-halide solid electrolyte material, comprising: LiAₓE_{y}G_{z}, or NaAₓE_{y}G_{z}, where A denotes one or more element selected from the group consisting of magnesium (Mg), calcium (Ca), strontium (Sr), barium (Ba), lanthanum (La), cerium (Ce), samarium (Sm), and boron (B). In embodiments, E denotes one or more chalcogen elements. In embodiments, G denotes one or more halide elements. In embodiments, the following mathematical formula is satisfied 0<x<10, 0<y<10, z=nx−2y+1. When n=3, A denotes at least one element selected from the group consisting of La, Ce, Sm, and Boron. When n=2, A denotes at least one element selected from the group consisting of Mg, Ca, Sr and Ba.

In embodiments, A is a single element selected from the group consisting of Mg, Ca, Sr, Ba, La, Ce, Sm, or B. In embodiments, A contains at least one element selected from the group consisting of Mg, Ca, Sr, Ba, La, Ce, and Sm. In embodiments, A contains at least one element selected from the group consisting of La, Ce, and Sm, and the following mathematical formula is satisfied: z=3x−2y+1. In embodiments, A contains at least one element selected from the group consisting of Mg, Ca, Sr, and Ba, and the following mathematical formula is satisfied: z=2x−2y+1. In embodiments, A contains at least one element selected from the group consisting of Ca and Ba, and the following mathematical formula is satisfied: z=2x−2y+1.

The chalcogen-halide solid electrolyte material exhibits improved chemical and mechanical compatibility with Li metal. Improved chemical compatibility meaning that the electrolyte is chemically stable with Li or Na metal or the electrolyte can form stable passivated layer by decomposition when contacted with Li or Na metal. Additionally, the disclosed chalcogen-halide solid electrolyte material has a low reduction potential, compared to conventional standard electrode potentials. The reduction potential refers to the potential where the electrolyte can be reduced. The lower the reduction potential of the electrolyte is, the better the compatibility with Li or Na metal.

The elements Mg, Ca, Sr, Ba, La, Ce, Sm, and B each have low reduction potentials compared to conventional standard electrode potentials. All of these elements, except boron, have lower standard electrode potentials (e.g., less than or equal to −2.3 V) than the Al (Al/Al³⁺, −1.662 V) in a conventional MACO electrolyte. Specifically, Mg/Mg²⁺ (−2.372 V), Ca/Ca²⁺ (−2.868 V), Sr/Sr²⁺ (−2.899 V), Ba/Ba²⁺ (−2.912 V), La/La³⁺ (−2.372 V), Ce/Ce³⁺ (−2.336 V), Sm/Sm³⁺ (−2.304 V). Among those elements, Ca has the best stability with Li or Na metal, resulting from its low standard electrode potential (Ca/Ca²⁺, −2.868 V). For reference, the potential of Li/Li⁺ and Na/Na⁺ are −3.0401 V and −2.71 V respectively. Accordingly, the disclosed elements listed above are more stable towards Lithium metal anode than “Al” in a conventional MACO electrolyte.

With respect to boron, boron is chosen due to the reduction products of boron (B⁰) with lithium (or sodium). The reaction products have low electronic conductivities (0.0001 S/m). Such low electronic conductivities help to stabilize the interface when in contact with a lithium/sodium metal anode.

In embodiments, the chalcogen elements comprises one of: oxygen (O); sulfur(S); or selenium (Se). In embodiments, the halide elements comprises one of: fluorine (F); chlorine (Cl); bromine (Br); or iodine (I). In embodiments, E denotes oxygen. In embodiments where E denotes oxygen, A contains at least one element selected from the group consisting of Mg, Ca, Sr, Ba, La, Ce, and Sm. In embodiments where E denotes oxygen, A contains at least one element selected from the group consisting of La, Ce, and Sm, and the following mathematical formula is satisfied: z=3x−2y+1. In embodiments where E denotes oxygen, A contains at least one element selected from the group consisting of Mg, Ca, Sr, and Ba, and the following mathematical formula is satisfied: z=2x−2y+1. In embodiments, E denotes oxygen, A contains at least one element selected from the group consisting of Ca and Ba, and the following mathematical formula is satisfied: z=2x−2y+1.

In reference to the elements listed above that may be selected as E and the elements listed above that may be selected as G, when E is O and G is Cl the resulting electrolytes have the highest oxidation potential and lowest cost. The high oxidation potential of the electrolytes results from O and CI, which have the highest potential to oxidize. Additionally, O and Cl are the cheapest of the listed elements.

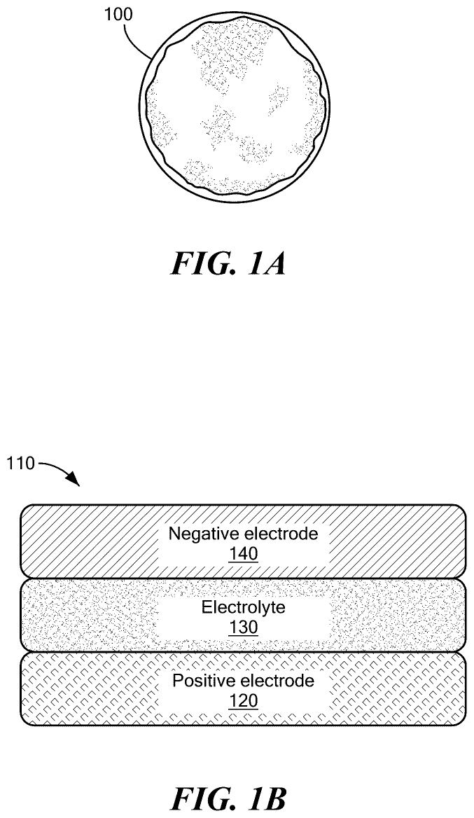

FIG. 1A is a top view of a chalcogen-halide solid electrolyte material 100. The material 100 includes Li—X—O-chlorine (CI), where X=B. Accordingly, the chemical formula for electrolyte material 100 is LiBO_{0.3}Cl_{3.4}. This LiBO_{0.3}Cl_{3.4} is made by a reaction between BCl₃, LiOH, and LiCl. The reaction equation is: BCl₃+0.3 LiOH+0.7 LiCl═LiBO_{0.3}Cl_{3.4} +0.3 HCl ⬆. The BCl₃ gas is purged in a 0.3 LiOH-0.7LiCl ethanol solution at room temperature (25° C.). After the reaction, LiBO_{0.3}Cl_{3.4} is obtained.

FIG. 1B is an exemplary schematic of an electrochemical cell 110 (which may be referred to herein as a battery), including the chalcogen-halide solid electrolyte material. An electrolyte layer 130 is disposed on a positive electrode 120. A negative electrode 140 is disposed on the electrolyte layer 130. The electrolyte layer 130 separates the negative electrode 140 and the positive electrode 120. The electrolyte layer 130 is used to conduct ions, but not electrons. The electrolyte layer 130 comprises a chalcogen-halide solid electrolyte material, such as any of the chalcogen-halide solid electrolyte materials described herein.

In embodiments, the battery includes a positive electrode and an electrolyte layer disposed on the positive electrode. In embodiments, the electrolyte layer comprises a chalcogen-halide solid electrolyte material, comprising: LiAₓE_{y}G_{z}, or NaAₓE_{y}G_{z}. In embodiments, A denotes one or more elements selected from the group consisting of magnesium (Mg), calcium (Ca), strontium (Sr), barium (Ba), Lanthanum (La), cerium (Ce), samarium (Sm), and boron (B). In embodiments, E denotes one or more chalcogen elements. In embodiments, G denotes one or more halide elements. In embodiments, the following mathematical formula is satisfied: 0<x<10, 0<y<10, z=nx−2y+1, where n=3 when A denotes at least one element selected from the group consisting of La, Ce, Sm, and B, and n=2 when A denotes at least one element selected from the group consisting of Mg, Ca, Sr, and Ba. In embodiments, the battery includes a negative electrode disposed on the electrolyte layer.

In embodiments, A is a single element selected from the group consisting of Mg, Ca, Sr, Ba, La, Ce, Sm, or B. In embodiments, A contains at least one element selected from the group consisting of La, Ce, and Sm, and the following mathematical formula is satisfied: z=3x−2y+1. In embodiments, A contains at least one element selected from the group consisting of Ca and Ba, and the following mathematical formula is satisfied: z=2x−2y+1. In embodiments, E denotes oxygen. In embodiments where E denotes oxygen, A contains at least one element selected from the group consisting of La, Ce, and Sm, and the following mathematical formula is satisfied: z=3x−2y+1. In embodiments where E denotes oxygen, where A contains at least one element selected from the group consisting of Ca and Ba, and the following mathematical formula is satisfied: z=2x−2y+1.

The electrolyte layer 130 may be rolled to a desired thickness by utilizing a hot forming process. Rolling the electrolyte layer is carried out with a roller.

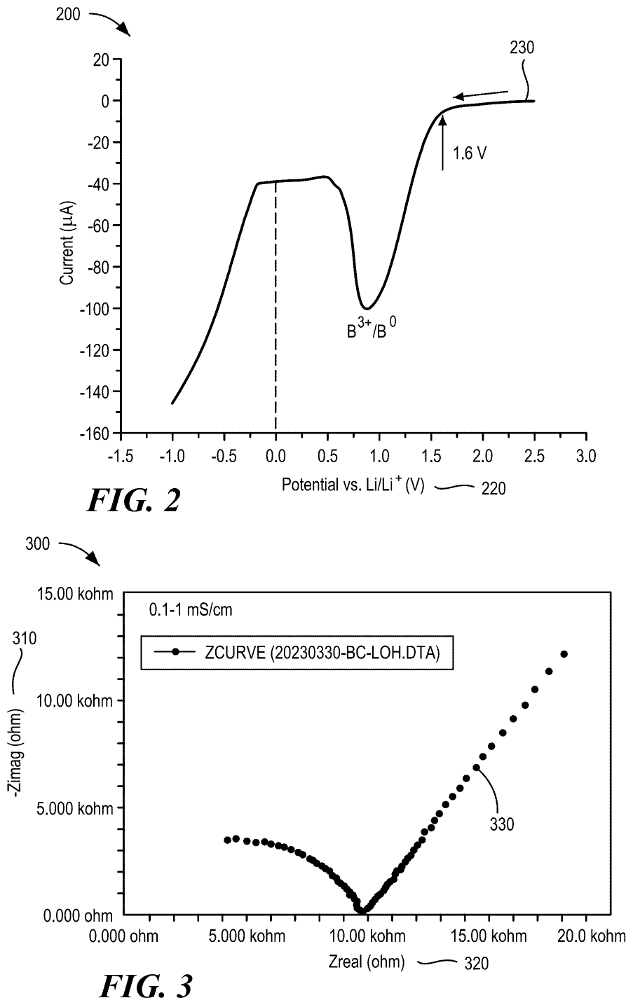

FIG. 2 is a graph 200 of an linear sweep voltammetry (LSV) test of LiBO_{0.3}Cl_{3.4} at room temperature. The current (μA) 210 vs. potential vs. Li/Li⁺ (V) 220 illustrates the reduction potential in a line 230. Graph 200 illustrates the results for testing performed with the electrolyte material 100, with a scan rate of 0.1 mV s-1.

In FIG. 2, the LSV curve of a chalcogen-halide solid electrolyte material LiBO_{0.3}Cl_{3.4}, illustrated in a line 230, includes a peak between 0.5 V and 1.6 V vs Li⁺/Li, indicating the reduction of B³⁺ to B⁰. However, when the potential further sweeps below 0 V, the current starts to decrease again, which corresponds to the plating of Li metal.

FIG. 3 is a graph 300 of a Nyquist plot illustrating -Zimag (ohm) 310 vs. Zreal (ohm) 320 for a chalcogen-halide solid electrolyte material LiBO_{0.3}Cl_{3.4}, with the results given in a line 330. Graph 300 illustrates the results for testing performed with the electrolyte material 100. The ionic conductivity calculated based on the test result is 0.4 mS/cm.

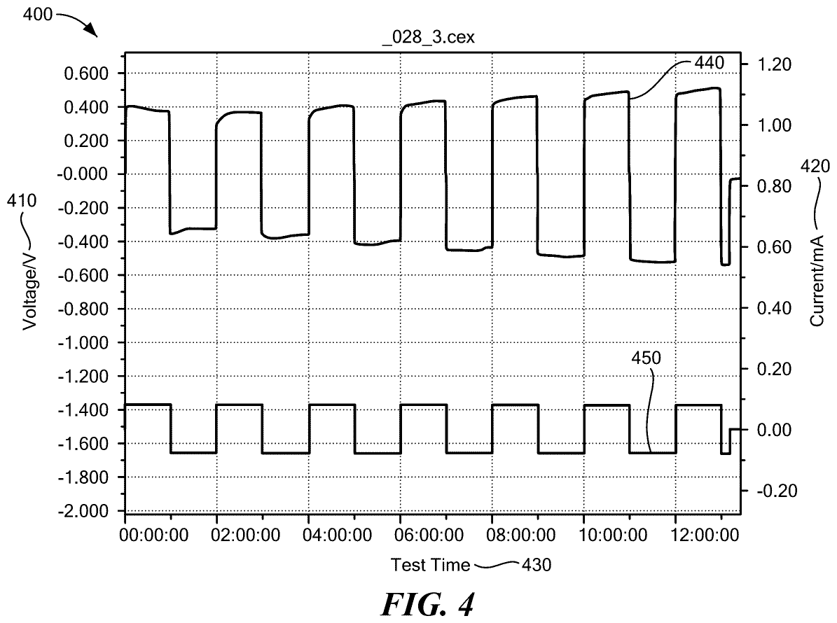

FIG. 4 is a graph 400 of voltage (V) 410 and current (mA) 420 vs. test time (min) 430 for a symmetric cell using a chalcogen-halide solid electrolyte material LiBO_{0.3}Cl_{3.4}. Voltage is illustrated in a line 440 and current is illustrated in a line 450. Graph 400 demonstrates the results for testing performed with the electrolyte material 100 in a Li—Li symmetric cell, meaning a cell with negative and positive electrodes include Li and an electrolyte material layer includes LiBO_{0.3}Cl_{3.4}. The stable cycling performance illustrates how LiBO_{0.3}Cl_{3.4} is kinetically compatible with a lithium metal anode. This is due in part to the B° in the decomposition products, which can passivate the interface due to their low electronic conductivity.

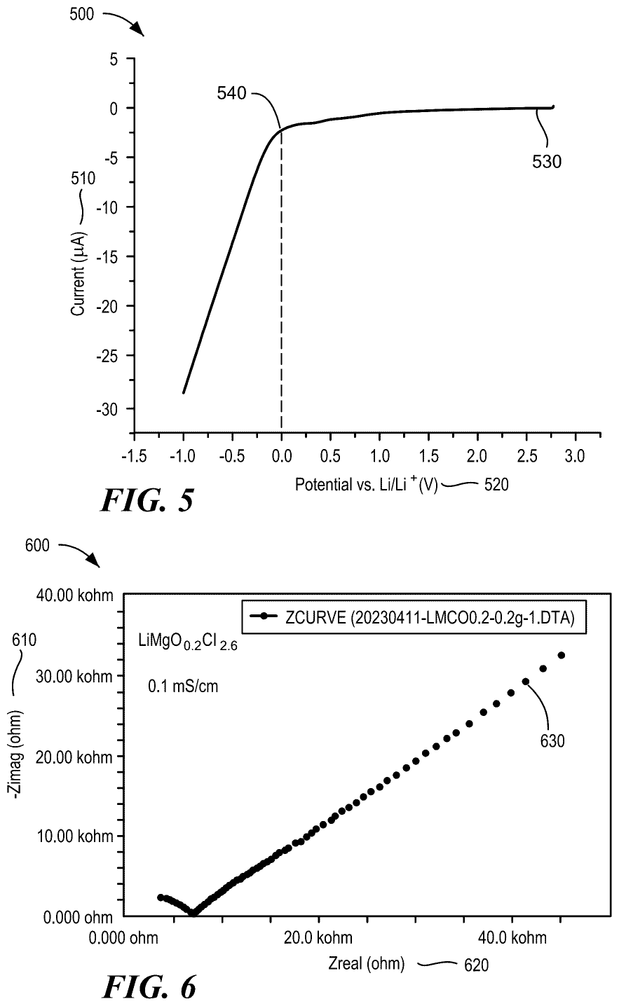

FIG. 5 is a graph 500 of an LSV test result of a chalcogen-halide solid electrolyte material Li—X—O—Cl, where X═Mg. Accordingly, the chemical formula for the electrolyte material used in the testing in FIG. 5 is LiMgO_{0.2}Cl_{2.6}. The chalcogen-halide solid electrolyte material was tested with a scan speed of 0.1 mV/s at room temperature. The graph 500 illustrates current (μA) 510 vs. potential vs. Li/Li⁺ (V) 520, illustrating the reduction potential in a line 530 for the chalcogen-halide solid electrolyte material. The LiMgO_{0.2}Cl_{2.6} is made by mixing MgCl₂, LiCl, and Sb₂O₃ and heating the mixture up to 700° C. for 0.5 hours. The reaction equation is: MgCl₂+LiCl+0.067 Sb₂O₃═LiMgO_{0.2}Cl_{2.6} +0.134 SbCl₃⬆. Because the boiling temperature of SbCl₃ is 220.3° C., SbCl₃ is evaporated out of the mixture at 700° C. Once cooled down, LiMgO_{0.2}Cl_{2.6} is obtained.

In FIG. 5, the reduction current starts to increase when the potential sweeps below 0 V vs Li⁺/Li at point 540, which demonstrates the stability of LiMgO_{0.2}Cl_{2.6} with lithium metal. Compared with FIG. 2, there is no reduction current peak above 0 V, indicating that LiMgO_{0.2}Cl_{2.6} has a better stability with lithium metal than LiBO_{0.3}Cl_{3.4}. In addition, as discussed above conventional MACO electrolytes are not stable with an anode with a redox potential lower than 1.45 V vs Li⁺/Li (for a MACO electrolyte where M stands for Li) and 1.55 V vs Na⁺/Na (for a MACO electrolyte where M stands for Na). Thus, the results discussed herein indicate the stability of LiMgO_{0.2}Cl_{2.6} between lithium metal is notably enhanced, compared to conventional MACO electrolytes.

FIG. 6 is a graph 600 of a Nyquist plot illustrating of -Zimag (ohm) 610 vs. Zreal (ohm) 620 for a chalcogen-halide solid electrolyte material, with the results given in a line 630. Graph 600 illustrates the results for testing performed with a chalcogen-halide solid electrolyte material Li—X—O—Cl, where X═Mg. Accordingly, the chemical formula for the electrolyte material used in the testing of FIG. 6 is LiMgO_{0.2}Cl_{2.6}. The ionic conductivity calculated based on the test result is 0.1 mS/cm.

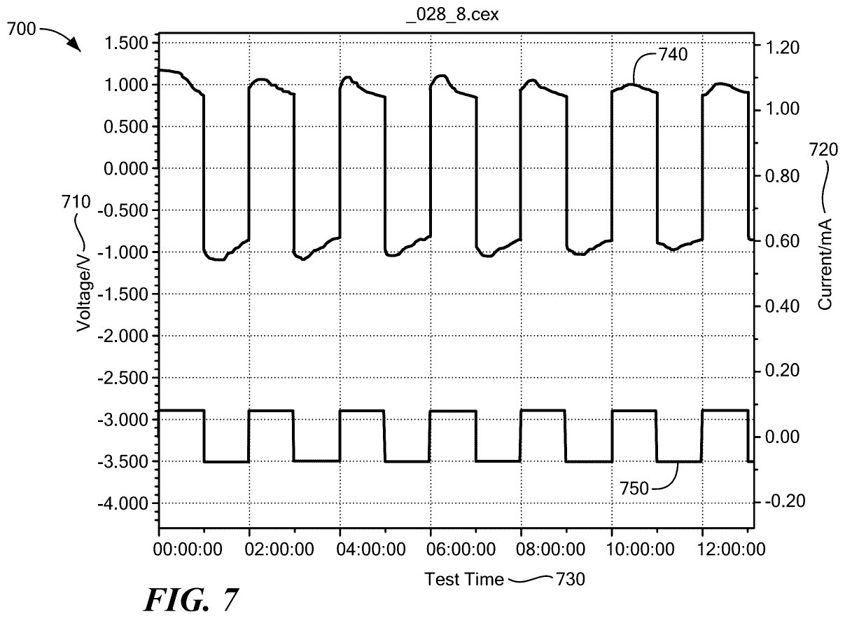

FIG. 7 is a graph 700 of voltage (V) 710 and current (mA) 720 vs. test time (min) 730 for a symmetric cell using a chalcogen-halide solid electrolyte material, Li—X—O—CI, where X═Mg. Accordingly, the chemical formula for the electrolyte material used in the testing of FIG. 7 is LiMgO_{0.2}Cl_{2.6}. Graph 700 illustrates the results for testing performed with the electrolyte material in a Li—Li symmetric cell at 0.1 mA/cm² and room temperature, meaning a cell with negative and positive electrodes includes Li and an electrolyte material layer includes LiMgO_{0.2}Cl_{2.6}. Voltage is illustrated in a line 740 and current is illustrated in a line 750. The stable cycling performance demonstrates how notably stable LiMgO_{0.2}Cl_{2.6} is with a lithium metal anode.

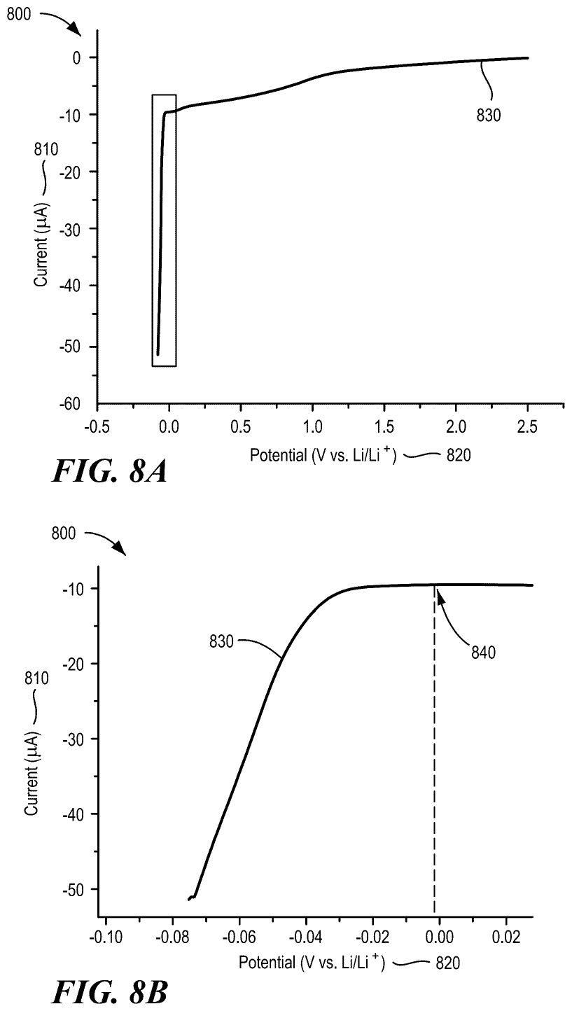

FIG. 8A is a graph 800 of an LSV test result for a chalcogen-halide solid electrolyte material Li—X—S-lodine (I), where X═Ca. Accordingly, the chemical formula for the electrolyte material used in the testing of FIG. 8A is LiCaS_{0.7}I_{1.6}. Graph 800 plots current (μA) 810 vs. potential vs. Li/Li⁺ (V) 820, illustrating reduction potential in a line 830 for the chalcogen-halide solid electrolyte. FIG. 8B is an enlarged view of the graph 800 disclosed in FIG. 8A. The testing was performed with a scan speed of 0.1 mV/s at room temperature. The LiCaS_{0.7}I_{1.6} is made by mixing Cal₂, Lil, and CaS, the mixture is heated up to 600° C. for 0.5 hours. The reaction equation is: 0.3 Cal₂+Lil+0.7 CaS═LiCaS_{0.7}I_{1.6}. After cooling down, LiCaS_{0.7}I_{1.6} is obtained.

In FIGS. 8A-8B, the reduction current (corresponding to the plating of lithium metal) arises when the potential sweeps below 0 V vs Li⁺/Li at point 840, which demonstrates the stability of LiCaS_{0.7}I_{1.6} with lithium metal. Compared with FIG. 2, there is no reduction current peak above 0 V, indicating that LiCaS_{0.7}I_{1.6} has a better stability with lithium metal than LiBO_{0.3}Cl_{3.4}. Compared with FIG. 5, LiCaS_{0.7}I^{1.6} and LiMgO_{0.2}Cl_{2.6} both show reduction current below 0 V, indicating they have the similar stability with a lithium metal anode. As discussed above, conventional MACO electrolytes are not stable with an anode with a redox potential lower than 1.45 V vs Lit/Li and 1.55 V vs Na⁺/Na. Accordingly, the stability of LiCaS_{0.7}I^{1.6} between lithium metal is notably enhanced, when compared to conventional MACO electrolytes.

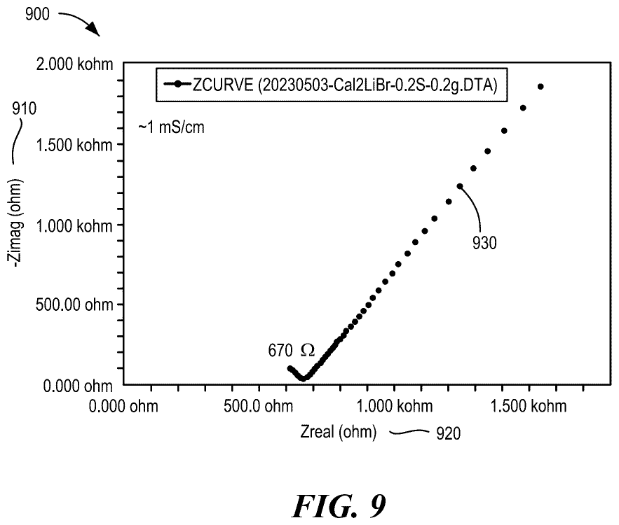

FIG. 9 is a graph 900 of a Nyquist plot illustrating of -Zimag (ohm) 910 vs. Zreal (ohm) 920 for a chalcogen-halide solid electrolyte material, with the results given in a line 930. Graph 900 illustrates the results for testing performed with a chalcogen-halide solid electrolyte material Li—X—S—I, where X═Ca. Accordingly, the chemical formula for the electrolyte material used in the testing of FIG. 9 is LiCaS_{0.7}I_{1.6}. The ionic conductivity calculated based on the test result is 1 mS/cm.

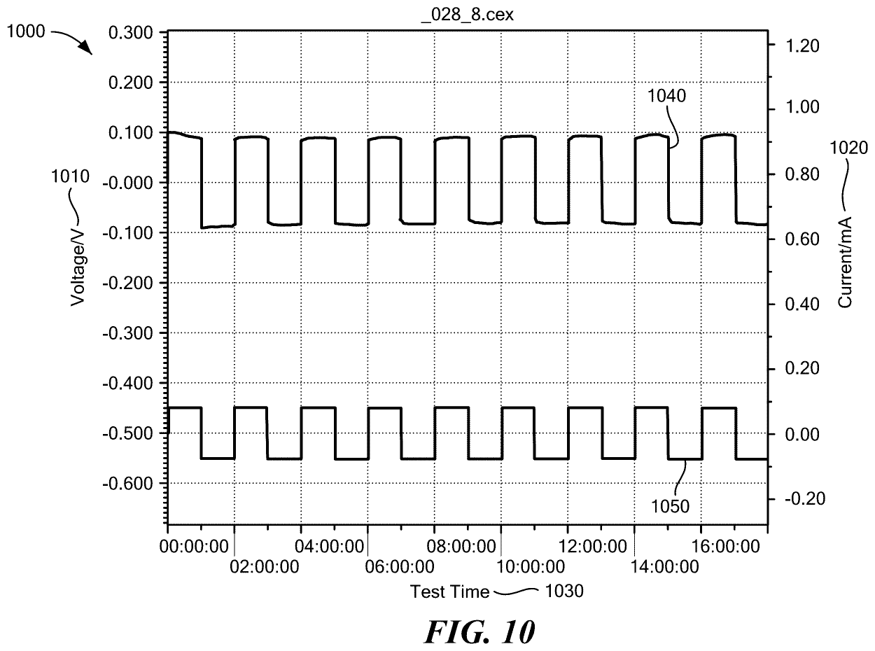

FIG. 10 is a graph 1000 of voltage (V) 1010 and current (mA) 1020 vs. test time (min) 1030 for a symmetric cell using a chalcogen-halide solid electrolyte material Li—X—S—I, where X═Ca. Accordingly, the chemical formula for the electrolyte material used in the testing of FIG. 10 is LiCaS_{0.7}I_{1.6}. Graph 1000 illustrates the results for testing performed with the electrolyte material in a Li—Li symmetric cell at 0.1 mA/cm² and room temperature, meaning a cell with negative and positive electrodes comprise Li and an electrolyte material layer comprises LiCaS_{0.7}I^{1.6}. Voltage is illustrated in a line 1040 and current in a line 1050. The stable cycling performance shows that LiCaS_{0.7}I_{1.6} is stable with a lithium metal anode.

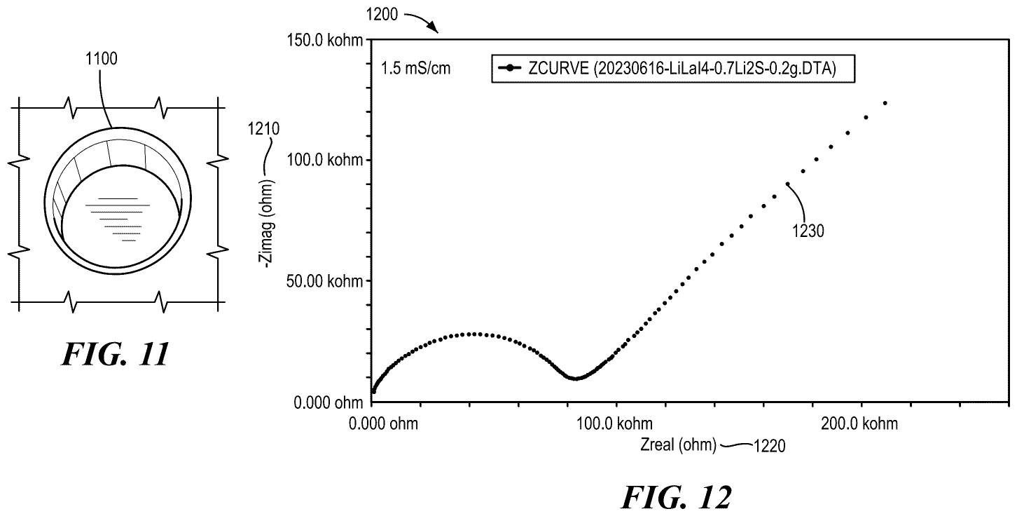

FIG. 11 is a top view of a chalcogen-halide solid electrolyte material 1100. The material 1100 includes Li—X—S—I, where X═La. Accordingly, the chemical formula for the electrolyte material 1100 is LiLaS_{0.7}I^{2.6}. This electrolyte is made by mixing Lal₃, Lil, and La₂S₃, the mixture is heated up to 600° C. for 0.5 hours. The reaction equation is: 0.53 Lal₃ +Lil+0.235 La₂S₃═LiLaS_{0.7}I_{2.6}. After cooling down, LiLaS_{0.7}I_{2.6} is obtained.

FIG. 12 is a graph 1200 of a Nyquist plot illustrating of -Zimag (ohm) 1210 vs. Zreal (ohm) 1220 for a chalcogen-halide solid electrolyte material, with the results given in a line 1230. Graph 1200 illustrates the results for testing with the material 1100 disclosed in FIG. 11. The ionic conductivity calculated based on the test result is 1.5 mS/cm.

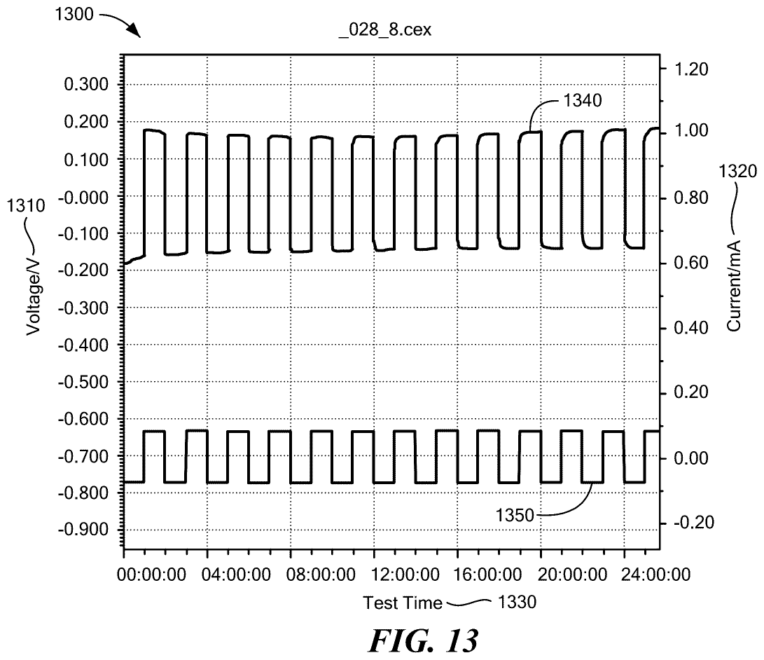

FIG. 13 is a graph 1300 of voltage (V) 1310 and current (mA) 1320 vs. test time (min) 1330. Graph 1300 illustrates the results for testing performed with the material 1100 disclosed in FIG. 11. Graph 1300 illustrates the results for testing performed with the material 1100 in a Li—Li symmetric cell at 0.1 mA/cm² and room temperature, meaning a cell with negative and positive electrodes comprise Li and an electrolyte material layer comprises LiLaS_{0.7}I_{2.6}. Voltage is illustrated in a line 1340 and current is illustrated in a line 1350. The stable cycling performance shows that the LiLaS_{0.7}I_{2.6} is stable with a lithium metal anode.

There are a number of benefits resulting from the disclosed chalcogen-halide solid electrolyte material, specifically the composite is cheaper and easier to manufacture due to the lower temperatures used and the hot forming process the composite is compatible with. Conventional processes for forming free-standing solid-state electrolyte membranes are either sintering for crystalline ceramics or maintaining high stacking pressure (greater than 2 MPa) during operation. In typical sintering, to get the electrolytes to full density, high temperatures (e.g., about 1000° C.+/−10° C.) are needed and are used for long periods of time (e.g., about 20 hours+/−1 hour). The higher temperature and time is called for because the initial composite begins with a powder and, because the chemicals used are crystalline, they do not deform easily. Accordingly, the battery is challenging and costly to manufacture.

Alternatively, other typical semiconductor processing techniques can be used (e.g., vapor deposition, etc.), but can be challenging to scale as they can become costly and complex. In addition, the high stacking pressure (greater than 2 MPa) in operation is not practical for most application scenarios. Further, the necessity of different fixtures to provide said pressure further reduces the energy density of the batteries.

In comparison, the disclosed chalcogen-halide solid electrolyte material provided in accordance with the concepts described herein, can be used in a hot forming process. The compositions provided in accordance with the concepts described herein can be rolled (e.g., with a stainless steel roller) to a desired thickness by utilizing a hot forming process, because the disclosed material is soft and viscous at low temperatures due to the low glass transition temperature (T_{g}). Accordingly, less time and lower temperatures can be used, making the material easily manufacturable. Use of a hot forming process results in batteries that are easier and less expensive to manufacture at scale than conventional batteries manufactured using sintering process, semiconductor process, or high-stacking-operation-pressure-needed process.

Another added benefit is the T_{g} of the chalcogen-halide solid electrolyte material, in some cases, can be lower than room temperature. Thus, the electrolyte is highly deformable at room temperature, enabling the ability to accommodate the strain and/or stress of electrode particles during cycling through creeping, while maintaining good adhesion force with the electrode particles. Accordingly, the stacking pressure during operation is not required in typical solid-state batteries.

Various embodiments of the concepts, systems, devices, structures and techniques sought to be protected are described herein with reference to the related drawings. Alternative embodiments can be devised without departing from the scope of the concepts, systems, devices, structures and techniques described herein. It is noted that various connections and positional relationships (e.g., over, below, adjacent, etc.) are set forth between elements in the following description and in the drawings. These connections and/or positional relationships, unless specified otherwise, can be direct or indirect, and the described concepts, systems, devices, structures and techniques are not intended to be limiting in this respect. Accordingly, a coupling of entities can refer to either a direct or an indirect coupling, and a positional relationship between entities can be a direct or indirect positional relationship.

As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s). The following definitions and abbreviations are to be used for the interpretation of the claims and the specification. As used herein, the terms “comprises,” “comprising, “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance, or illustration. Any embodiment or design described herein as “exemplary” is not necessarily to be construed as preferred or advantageous over other embodiments or designs. The terms “one or more” and “one or more” are understood to include any integer number greater than or equal to one, i.e. one, two, three, four, etc.

References in the specification to “one embodiment, “an embodiment,” “an example embodiment,” etc., indicate that the embodiment described can include a particular feature, structure, or characteristic, but every embodiment can include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper,” “lower,” “right,” “left,” “vertical,” “horizontal, “top,” “bottom,” and derivatives thereof shall relate to the described structures and methods, as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element. It should be noted that the term “selective to, “such as, for example, “a first element selective to a second element,” means that the first element can be etched and the second element can act as an etch stop.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

What is claimed is:

1. A chalcogen-halide solid electrolyte material, comprising:
LiAₓE_{y}G_{z} or NaAₓE_{y}G_{z},
wherein A denotes one or more elements selected from the group consisting of magnesium (Mg), calcium (Ca), strontium (Sr), barium (Ba), Lanthanum (La), cerium (Ce), samarium (Sm), and boron (B), E denotes one or more chalcogen elements, G denotes one or more halide elements, and the following mathematical formula is satisfied:
0<x<10, 0<y<10, z=nx−2y+1, wherein n=3 when A denotes at least one element selected from the group consisting of La, Ce, Sm, and B, and n=2 when A denotes at least one element selected from the group consisting of Mg, Ca, Sr, and Ba.

2. The chalcogen-halide solid electrolyte material of claim 1, wherein A is a single element selected from the group consisting of Mg, Ca, Sr, Ba, La, Ce, Sm, or B.

3. The chalcogen-halide solid electrolyte material of claim 1, wherein the chalcogen elements comprises one of: oxygen (O); sulfur(S); or selenium (Se).

4. The chalcogen-halide solid electrolyte material of claim 1, wherein the halide elements comprises one of: fluorine (F); chlorine (Cl); bromine (Br); or iodine (I).

5. The chalcogen-halide solid electrolyte material of claim 1, wherein A contains at least one element selected from the group consisting of Mg, Ca, Sr, Ba, La, Ce, and Sm.

6. The chalcogen-halide solid electrolyte material of claim 1, wherein A contains at least one element selected from the group consisting of La, Ce, and Sm, and the following mathematical formula is satisfied: z=3x−2y+1.

7. The chalcogen-halide solid electrolyte material of claim 1, wherein A contains at least one element selected from the group consisting of Mg, Ca, Sr, and Ba, and the following mathematical formula is satisfied: z=2x−2y+1.

8. The chalcogen-halide solid electrolyte material of claim 1, wherein A contains at least one element selected from the group consisting of Ca and Ba, and the following mathematical formula is satisfied: z=2x−2y+1.

9. The chalcogen-halide solid electrolyte material of claim 1, wherein E denotes oxygen.

10. The chalcogen-halide solid electrolyte material of claim 9, wherein A contains at least one element selected from the group consisting of Mg, Ca, Sr, Ba, La, Ce, and Sm.

11. The chalcogen-halide solid electrolyte material of claim 9, wherein A contains at least one element selected from the group consisting of La, Ce, and Sm, and the following mathematical formula is satisfied: z=3x−2y+1.

12. The chalcogen-halide solid electrolyte material of claim 9, wherein A contains at least one element selected from the group consisting of Mg, Ca, Sr, and Ba, and the following mathematical formula is satisfied: z=2x−2y+1.

13. The chalcogen-halide solid electrolyte material of claim 9, wherein A contains at least one element selected from the group consisting of Ca and Ba, and the following mathematical formula is satisfied: z=2x−2y+1.

14. A battery, comprising:
a positive electrode;
an electrolyte layer disposed on the positive electrode, the electrolyte layer comprising a chalcogen-halide solid electrolyte material comprising:
LiAₓE_{y}G_{z}, or NaAₓE_{y}G_{z}
wherein
A denotes one or more elements selected from the group consisting of magnesium (Mg), calcium (Ca), strontium (Sr), barium (Ba), Lanthanum (La), cerium (Ce), samarium (Sm), and boron (B), E denotes one or more chalcogen elements, G denotes one or more halide elements, and the following mathematical formula is satisfied:
0<x<10, 0<y<10, z=nx−2y+1, wherein n=3 when A denotes at least one element selected from the group consisting of La, Ce, Sm, and B, and n=2 when A denotes at least one element selected from the group consisting of Mg, Ca, Sr, and Ba; and
a negative electrode disposed on the electrolyte layer.

15. The battery of claim 14, wherein A is a single element selected from the group consisting of Mg, Ca, Sr, Ba, La, Ce, Sm, or B.

16. The battery of claim 14, wherein A contains at least one element selected from the group consisting of La, Ce, and Sm, and the following mathematical formula is satisfied: z=3x−2y+1.

17. The battery of claim 14, wherein A contains at least one element selected from the group consisting of Ca and Ba, and the following mathematical formula is satisfied: z=2x−2y+1.

18. The battery of claim 14, wherein E denotes oxygen.

19. The battery of claim 18, wherein A contains at least one element selected from the group consisting of La, Ce, and Sm, and the following mathematical formula is satisfied: z=3x−2y+1.

20. The battery of claim 18, wherein A contains at least one element selected from the group consisting of Ca and Ba, and the following mathematical formula is satisfied: z=2x−2y+1.
